(19) United States
(12) Patent Application Publication
(10) Pub. No.: US 2014/0111093 A1
(43) Pub. Date: Apr. 24, 2014

(54) AVERAGE LINEAR LED DRIVER CIRCUIT

(71) Applicant: Shanghai Bright Power Semiconductor Co., Ltd., Shanghai (CN)

(72) Inventors: Shungen Sun, Shanghai (CN); Liqiang Hu, Shanghai (CN)

(73) Assignee: SHANGHAI BRIGHT POWER SEMICONDUCTOR CO., LTD., Shanghai (CN)

(21) Appl. No.: 13/964,275

(22) Filed: Aug. 12, 2013

(30) Foreign Application Priority Data
Oct. 18, 2012 (CN) 201210396998.2

(51) Int. Cl. H05B 33/08

(52) U.S. Cl. CPC H05B 33/0812
USPC 315/127

(57) ABSTRACT

An average linear light-emitting diode (LED) driver circuit is disclosed. An inputting alternating-current (AC) voltage is connected to a rectifier bridge. An LED load is paralleled with a filtering capacitor and connected to a power switch. A compensation network and a voltage feedback network are included. When the output voltage of the rectifier bridge is higher than the voltage of the filtering capacitor, the drain voltage of the power switch is increased. The voltage feedback network decreases or turns off the current in the power switch. The compensation network controls the average current in the power switch to be equal to the desired LED load current. The average linear LED driver circuit intelligently controls the driver current, reduces the system power loss and increases the system efficiency. The LED driver maintains high conversion efficiency, especially under wide input voltage conditions.

### CROSS-REFERENCE TO RELATED APPLICATIONS

The present application claims priority from CN 201210396998.2 filed on Oct. 18, 2012, the disclosure of which is hereby incorporated herein by reference.

### FIELD OF THE INVENTION

The present invention relates generally to Light-Emitting Diode (“LED”) driver circuits; and more specifically to average linear LED driver circuits with high efficiency constant current.

### BACKGROUND

LED light sources have energy saving and environment friendly advantages. However the technical difficulty of the LED light sources is the instability of the control circuit, hence the lifetime of the LED lamps is limited. At present, the malfunction of the LED lamps is greatly related to a failure of the LED driver circuit.

FIG. 1 (Prior Art) is a diagram of a linear LED driver circuit. An AC voltage is rectified by a diode bridge 001. The output voltage of the diode bridge 001 is filtered by the capacitor C1, and a DC voltage is generated. The LED load is connected to the DC voltage, and the negative terminal of the LED load is connected to a current sink 002. The current sink 002 keeps the LED load current constant. The main disadvantage of this LED driver circuit is that when the input voltage is relatively high, the voltage drop of the current sink 002 is also high. The power loss and thermal dissipation on current sink 002 is increased, and the driver circuit efficiency and system reliability is decreased.

### SUMMARY OF THE INVENTION

The present invention has been developed to solve the problems of the prior art. The present invention provides an average linear LED driver circuit which can improve the efficiency of the driver circuit.

To achieve the above-mentioned object, the present invention discloses an average linear LED driver circuit. The driver circuit comprises a rectifier bridge connected to an input AC voltage and an LED load. The LED load paralleled with a filtering capacitor is connected to a power switch. The driver circuit further includes a compensation network and a voltage feedback network. When the output voltage of the rectifier bridge is higher than the voltage of the filtering capacitor, the drain voltage is increased, and the voltage feedback network decreases or turns off the current in the power switch. The compensation network controls the average current in the power switch to be equal to the LED load current.

Furthermore, the driver circuit also includes an operational amplifier. The voltage feedback network generates an output voltage according to the drain voltage of the power switch and the compensation network. When the drain voltage of the power switch is low, the output voltage is equal to the voltage of the compensation network, and when the drain voltage of the power switch is high, the output voltage is lower than the voltage of the compensation network.

Furthermore, the negative input end of the operational amplifier is connected to a current sensing resistor. The positive input end is connected to a reference voltage, and the output end of the operational amplifier is connected to the compensation network.

Furthermore, the driver circuit also includes a driver. The input end of the driver is connected to the voltage feedback network. The output end of the driver is connected to the gate of the power switch. The driver converts the output voltage of the feedback network to a driving voltage of the gate of the power switch.

Furthermore, the power switch is a Field-Effect Transistor or a Bipolar Junction Transistor (BJT).

Furthermore, the compensation network includes a resistor R2, capacitor C2 and capacitor C3. The resistor R2 is in series with the capacitor C2 and then paralleled with the capacitor C3.

Furthermore, the voltage feedback network is composed of a resistor R3, a resistor R4, a resistor R5, a resistor R6, a transistor Q1 and a buffer. One end of the resistor R3 is connected to the buffer (201), and the other end is connected to the gate of the power switch through a driver or directly. The collector of the transistor Q1 is connected to the resistor R3, and the emitter is connected to one end of the resistor R4, and the other end of the resistor R4 is grounded. One end of the resistor R5 is connected to the drain of the power switch, and the other end is connected to the base of the transistor Q1. One end of the resistor R6 is connected to the base of the transistor Q1, and the other end is grounded.

Furthermore, the power switch is composed of a first power switch and a second power switch in series. The gate of the first power switch is connected to the output end of the voltage feedback network. The drain of the first power switch is connected to the source of the second power switch. The drain of the second power switch is connected to negative input end of the voltage feedback network. The gate of the second power switch is connected to a power supply.

Compared with the prior art, the average linear LED driver circuit provided in the present invention intelligently controls the driver current, reduces the system power loss and increases the system efficiency. The LED driver maintains high conversion efficiency, especially under wide input voltage conditions.

### BRIEF DESCRIPTION OF THE DRAWINGS

The advantage and spirit of the invention may be understood by the following recitations together with the appended drawings.

FIG. 1 is a circuit diagram of a linear LED driver circuit in the prior art.

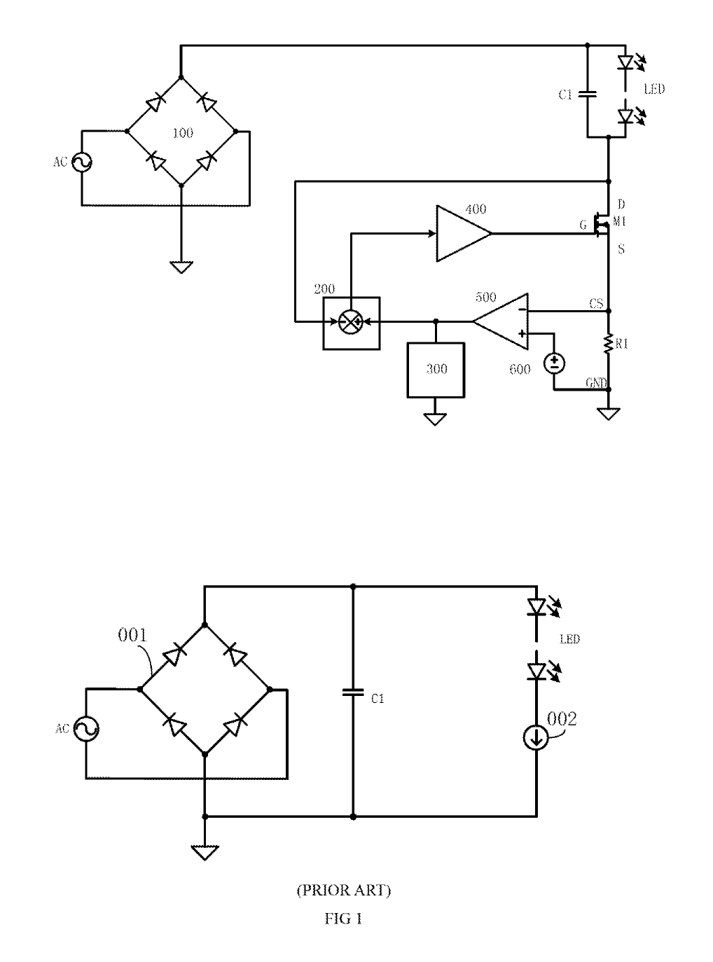

FIG. 2 is a circuit diagram of an average linear LED driver circuit illustrated in the present invention.

FIG. 3 is a typical waveform diagram that illustrates the operation of the average linear LED driver circuit illustrated in the present invention.

FIG. 4 is a circuit diagram of the compensation network and voltage feedback network of the average linear LED driver circuit illustrated in the present invention.

FIG. 5 is a circuit diagram of another embodiment of the average linear LED driver circuit illustrated in the present invention.

### DETAILED DESCRIPTION

The embodiments according to the invention are hereinafter described with reference to the drawings.

For solving the problem that the efficiency of the LED driver circuit is low and the system is liable to failure in the prior art, the present invention provides an average linear LED driver circuit. In the average linear LED driver circuit, a filtering capacitor is directly paralleled with an LED load. An electric current would flow through the power switch when the input voltage output from the rectifier is slightly higher than the voltage of the filtering capacitor. The electric current would be reduced or cut when the input voltage output from the rectifier is much higher than the voltage of the filtering capacitor, and the average value of the current in the power switch is equal to the LED load current, thereby the purpose of high efficient LED driving is achieved.

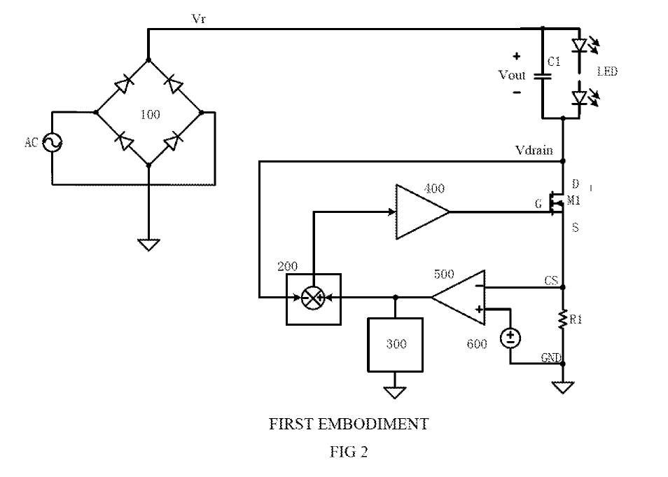

FIG. 2 is a circuit diagram of an average linear LED driver circuit illustrated in the present invention. In the average linear LED driver circuit provided in the present invention, the LED driver includes a rectifier, such as a diode bridge 100, that passes the positive half-cycle of a power AC voltage (e.g., a sinusoidal waveform) and inverts the negative half cycle of the power AC voltage, thereby resulting in a full wave rectified voltage Vr.

The rectified voltage Vr is connected to the positive terminal of the LED load. The LED load could be a number of series-connected or parallel-connected LEDs. A filtering capacitor C1 is paralleled with the LED load to store the energy and to smooth the LED load current.

A power switch M1 is connected to the negative terminal of the LED load and also the filtering capacitor C1. The power switch M1 could be a Metal-Oxide-Semiconductor Field-Effect Transistor (MOSFET) or a Bipolar Junction Transistor (BJT). Although the MOSFET device is illustrated here, it is appreciated that other types of transistor may be used as well.

A compensation network 300 is implemented. The function of the compensation network 300 is to integrate the error signal between the reference and current sensing signal to make sure that the current in the power switch M1 is same as the designed current value. Since the LED load current is equal to the power switch M1 drain current, the LED load current can be programmed by the current sensing resistor R1 in accordance with the reference voltage 600.

A voltage feedback network 200 is implemented. The function of the voltage feedback network 200 is to modulate the output voltage of the power switch gate driver. When the drain voltage of the power switch M1 is low, the output of the voltage feedback network 200 is equal to the voltage of the compensation network 300. When the drain voltage of the power switch M1 increases, the output of the voltage feedback network 200 is decreased to reduce the power switch M1 current or turn off the power switch M1.

An operational amplifier 500 is implemented. The negative input of the operational amplifier 500 is connected to a current sensing resistor R1. The positive input of the operational amplifier 500 is connected to a reference voltage 600. The output of the operational amplifier 500 is connected to the compensation network 300. The operational amplifier 500 compares the voltage on the current sensing resistor R1 with the reference voltage 600, and generates an output current according to the error between the voltage on the current sensing resistor R1 and the reference voltage 600. The error current is fed into the compensation network 300 to generate a compensation voltage.

A power switch driver 400 is implemented. The input of the power switch driver 400 is connected to the voltage feedback network 200. The output of the power switch driver 400 is connected to the gate of the power switch M1. The power switch driver 400 converts the output voltage of the feedback network 200 to a driving voltage of the gate of the power switch M1.

Since the input source is the power AC voltage, the rectifier 100 generates a full wave rectified voltage Vr. Vr sometimes is higher than the filtering capacitor C1 voltage Vout, and sometimes is lower than Vout. When the full wave rectified voltage Vr is slightly higher than the filtering capacitor C1 voltage Vout, the drain voltage of the power switch M1 is Vdrain=Vr−Vout. The current will flow from input source to the rectifier 100, then to the filtering capacitor C1 and LED load, then to the power switch M1, then to the current sensing resistor R1, and then to the system GND and returns to the rectifier 100 and input source. The current flowing through current sensing resistor R1 generates a sensing voltage. The sensing voltage represents the current flowing in the LED load and the filtering capacitor C1. The operational amplifier 500 compares the sensing voltage with the reference voltage 600 and outputs a current or voltage error signal. The compensation network 300 processes the error signal and generates a compensation voltage for the voltage feedback network 200. The voltage feedback network 200 receives the compensation voltage and the drain voltage of the power switch M1 and generates a gate driver voltage through power switch driver 400.

When the full wave rectified voltage Vr is relatively higher than the filtering capacitor C1 voltage, Vout, the current continues flowing through the power switch M1, and a considerable power loss will be generated on the power switch M1, and hence reduce the system efficiency and reliability. In this average linear LED driver circuit, when the drain voltage of the power switch is relatively high, the voltage feedback network 200 reduces the gate driver voltage of the power switch M1, and hence reduces the current in the power switch M1 or turns off the power switch M1, thereby achieving intelligent control of the LED driver.

Though the current flowing in current sensing resistor R1 is not continuous, the operational amplifier 500 and the compensation network can integrate the current signal so that the average current flowing through the power switch M1 and also the LED load is under control. The LED load current is equal to the reference voltage dividing the value of current sensing resistor.

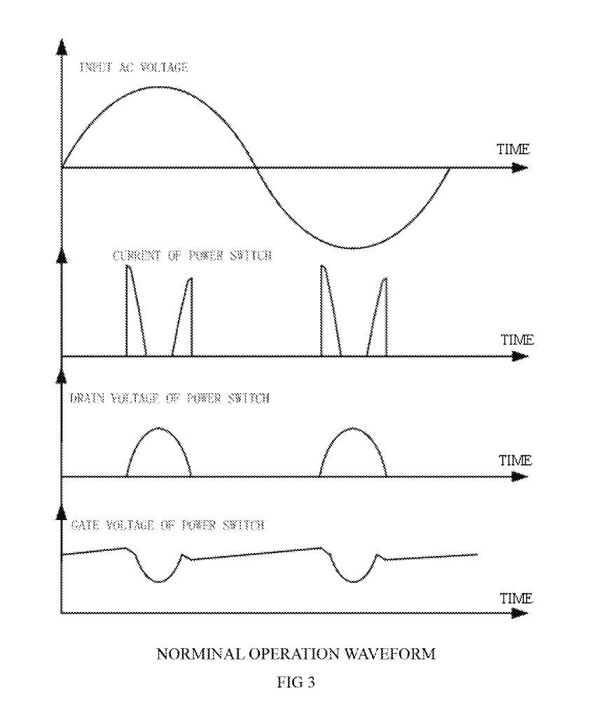

FIG. 3 is a waveform diagram that illustrates the operation of the disclosed average linear LED driver circuit. As shown in FIG. 3, when the input voltage is a sinusoidal waveform, the power switch M1 current is a “two pulse” shape waveform. When the drain voltage of the power switch is high, the power switch M1 current is decreased or turned off.

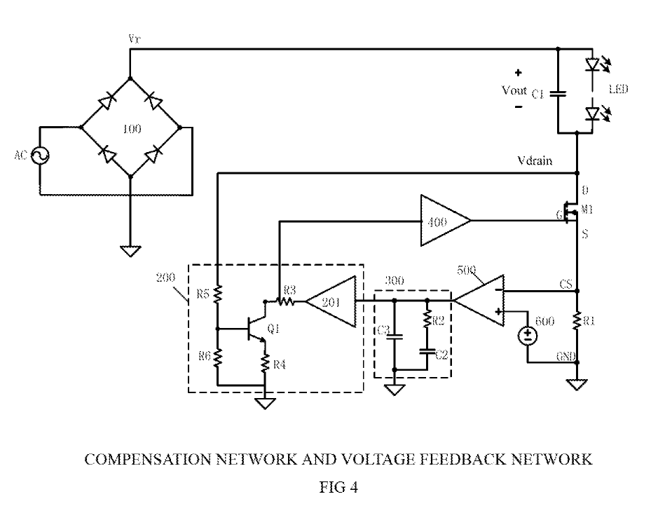

FIG. 4 is a diagram of an embodiment of the compensation network 300 and voltage feedback network 200. As shown in FIG. 4, the compensation network 300 can be implemented by a resistor and capacitor network, typically including a resistor R2, capacitor C2 and capacitor C3. The resistor R2 is in series with capacitor C2 and then paralleled with capacitor C3. One terminal of the compensation network 300 is connected to the operational amplifier 500. Another terminal of the compensation network 300 is connected to the system ground. The compensation network 300 integrates the output current of the operational amplifier 500 and results in a compensation voltage.

The compensation network 300 can also be implemented by a simple capacitor. One terminal of the capacitor is connected to the output of the operational amplifier 500. Another terminal of the capacitor is connected to the system ground. The capacitor can integrate the output current of the operational amplifier 500 and result in a compensation voltage.

As shown in FIG. 4, an embodiment of the voltage feedback network 200 is composed of resistor R3, R4, R5, R6, transistor Q1 and buffer 201. One end of resistor R3 is connected to the buffer 201, and another end of the resistor R3 is connected to the power switch driver 400. The base of transistor Q1 is connected to resistor R3, the emitter of transistor Q1 is connected to resistor R4, and the other end of resistor R4 is grounded. One end of resistor R5 is connected to the drain of power switch M1, and another end is connected to the base of transistor Q1. One end of resistor R6 is connected to resistor R5 and the base of transistor Q1, and another end of resistor R6 is grounded.

When the drain voltage of the power switch M1 is relatively high, current flows from the base of transistor Q1 to the emitter of transistor Q1, hence current also flows from the collector of transistor Q1 to the emitter of transistor Q1. The collector current of transistor Q1 creates a voltage drop across the resistor R3, and lowers the output voltage of the voltage feedback network, thereby reducing the gate voltage of the power switch M1 and the current of the power switch M1 so that the power loss is decreased.

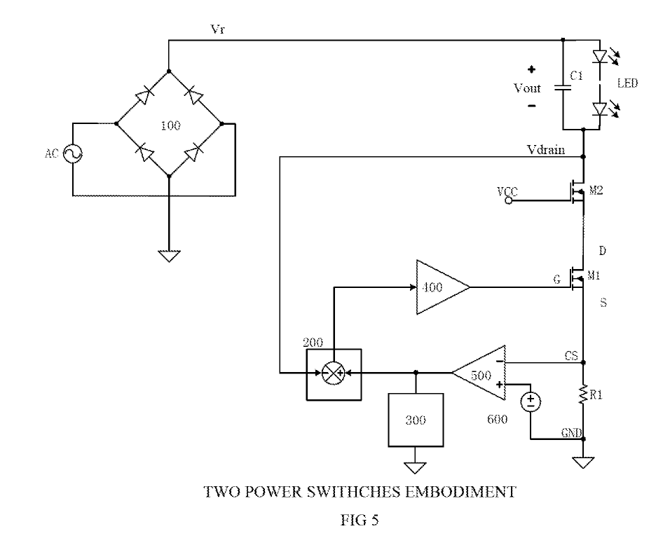

Another embodiment of the power switch is cascading the power switch transistors, as shown in FIG. 5, wherein the power switch is composed of the first power switch M1 and the second power switch M2. The gate of the first power switch M1 is connected to the power switch driver 400. The drain of the first power switch M1 is connected to the source of the second power switch M2. The drain of the second power switch M2 is connected to the voltage feedback network. The gate of the second power switch M2 is connected to a power supply.

The disclosed average linear LED driver circuit can intelligently control the current in the driver, keeping the LED load current regulated while reducing the system power dissipation, also increasing the overall efficiency, especially under wide input voltage condition.

While the invention has been described in terms of what is presently considered to be the most practical and preferred embodiments, it is to be understood that the invention need not be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An average linear LED driver circuit comprises a rectifier bridge connected to an input AC voltage and an LED load, characterised in that,
the LED load paralleled with a filtering capacitor is connected to a power switch;
the driver circuit further includes a compensation network and a voltage feedback network;
when the output DC voltage of the rectifier bridge is higher than the voltage of the filtering capacitor, the drain voltage is increased;
the voltage feedback network decreases or turns off the current in the power switch;
the compensation network controls the average current in the power switch to be equal to the LED load current.

2. The average linear LED driver circuit of claim 1, characterised in that the driver circuit further includes an operational amplifier; the voltage feedback network generates an output voltage according to the drain voltage of the power switch and the compensation network; when the drain voltage of the power switch is low, the output voltage is equal to the voltage of the compensation network; when the drain voltage of the power switch is high, the output voltage is lower than the voltage of the compensation network.

3. The average linear LED driver circuit of claim 2, characterised in that the negative input end of the operational amplifier is connected to a sampling resistor; the positive input end is connected to a reference voltage; the output end of the operational amplifier is connected to the compensation network.

4. The average linear LED driver circuit of claim 1, characterised in that the driver circuit further includes a driver; the input end of the driver is connected to the voltage feedback network; the output end of the driver is connected to the gate of the power switch; the driver converts the output voltage of the feedback network to a driving voltage of the gate of the power switch.

5. The average linear LED driver circuit of claim 1, characterised in that the power switch is a Field-Effect Transistor or a Bipolar Junction Transistor (BJT).

6. The average linear LED driver circuit of claim 1, characterised in that the compensation network includes a capacitor C3.

7. The average linear LED driver circuit of claim 1, characterised in that the compensation network includes a resistor R2, capacitor C2 and capacitor C3; the resistor R2 is in series with the capacitor C2 and then paralleled with the capacitor C3.

8. The average linear LED driver circuit of claim 2, characterised in that the voltage feedback network is composed of a resistor R3, a resistor R4, a resistor R5, a resistor R6, a transistor Q1 and a buffer; one end of the resistor R3 is connected to the buffer, the other end is connected to the gate of the power switch through a driver or directly; the resistor R3 is connected to the gate of the power switch directly, the collector of the transistor Q1 is connected to the resistor R3, the emitter is connected to one end of the resistor R4, the other end of the resistor R4 is grounded; one end of the resistor R5 is connected to the drain of the power switch, the other end is connected to the base of the transistor Q1; one end of the resistor R6 is connected to the base of the transistor Q1, the other end is grounded.

9. The average linear LED driver circuit of claim 1, characterized in that the power switch is composed of a first power switch and a second power switch in series; the gate of the first power switch is connected to the output end of the voltage feedback network; the drain of the first power switch is connected to the source of the second power switch; the drain of the second power switch is connected to negative input end of the voltage feedback network; the gate of the second power switch is connected to a power supply.
